(19) United States
(12) Patent Application Publication
(10) Pub. No.: US 2008/0055509 A1
(43) Pub. Date: Mar. 6, 2008

(54) COLOR BACKLIGHT DEVICE AND LIQUID CRYSTAL DISPLAY THEREOF

(75) Inventors: Chao-Kai Cheng, Miaoli County (TW); Yuh-Zheng Lee, Hsinchu City (TW); Jih-Fon Huang, Hsinchu County (TW); Chieh-Yi Huang, Hsinchu County (TW); Wan-Wen Chiu, Hsinchu County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/849,473

(22) Filed: Sep. 4, 2007

(30) Foreign Application Priority Data
Sep. 5, 2006 (TW) TW95132716

(51) Int. Cl. G02F 1/1335; F21V 21/00; G02F 1/136; H01J 9/14

(52) U.S. Cl. 349/48; 349/69; 349/70; 362/249; 445/52

(57) ABSTRACT

A color backlight device and fabrication method thereof is provided. A surface conduction emitter display with more than one color serves as the color backlight device. The color backlight device can be used in a liquid crystal display (LCD) to obviate the use of a color filter. The invention also provides a color display control method of the LCD and a pixel arrangement method of the color backlight device.

### BACKGROUND OF THE INVENTION

1. Field of the Invention

The invention relates to a color backlight device, and more particularly to a color backlight device with a surface conduction emitter display and a liquid crystal display containing the color backlight device.

2. Description of the Related Art

Self-emitting displays are a kind of flat panel display. Self-emitting displays include plasma display panels (PDP), field emission displays (FED) and a surface conduction emitter displays (SED) all of which produce light by emitting electrons to stimulate phosphorus materials, thus producing a full color display.

U.S. Pat. No. 6,986,692 discloses a method of producing a surface conduction emitter display. FIG. 1 is a perspective view of the surface conduction emitter display 170. A plurality of horizontal electrodes 107 is disposed perpendicular to a plurality of vertical electrodes 106 on a rear substrate 101. An electron emitter 113 is formed between the electrodes 106 and 107. A light emitting layer 11, comprised of red, green, and blue (RGB) phosphorus materials is formed on a front substrate 110 facing the rear substrate 101. A spacer 120 is disposed on the vertical electrode 106 electrically connecting the vertical electrode 106 and a metal backing 112. A frame 109 is disposed between the front substrate 110 and the rear substrate 101 to seal the surface conduction emitter display 170.

A conventional thin-film transistor liquid crystal display (TFT-LCD) comprises thin-film transistors (TFTs), liquid crystal molecules, a color filter, polarizers, and a backlight module among others. The driving method for LCD comprises adjusting a controlled voltage of the thin-film transistors by driver ICs such that one direction of a linear polarized light through the liquid crystal is turned into an elliptical polarized light and the other direction of the linear polarized light forms a gray level effect. Color display is achieved emission of a white light from the backlight module passing through the liquid crystal and the polarizers. The controlled voltage of the thin-film transistors is then adjusted and subsequently passed through the color filter.

Because cost is high and yield of aligned front and rear substrates is low, a display eliminating a color filter and a method not requiring accurate alignment of front and rear substrates is desirable.

### BRIEF SUMMARY OF THE INVENTION

The invention seeks to provide a liquid crystal display comprising a color backlight device fabricated without a color filter. A method for controlling color of the liquid crystal display and a method of arranging a plurality of pixels of the color backlight device is also provided.

The color backlight device comprises a plurality of first strip electrodes disposed on a first substrate and a plurality of electron emitters disposed between the first strip electrodes. A second substrate disposed opposite to the first substrate and a plurality of stimulated luminescent materials disposed on the second substrate aligned with the electron emitters.

The invention further provides a method of fabricating a color backlight device, comprising forming a plurality of first strip electrodes on a first substrate. A plurality of thin films is printed between the first strip electrodes. An electric field is applied to the thin film forming a sub-micron gap therein. An activation process is then performed on the thin films such that the sub-micron gap shrinks into a nano gap, thereby forming an electron emitter. A plurality of stimulated luminescent materials is subsequently disposed on a second substrate. The first substrate is assembled opposite to the second substrate such that the stimulated luminescent materials are aligned with the electron emitter.

The invention further provides a liquid crystal display without a color filter. The liquid crystal display comprises a second substrate disposed opposite to a first substrate. A liquid crystal layer is disposed between the first substrate and the second substrate. An electrode layer of a thin-film transistor array is disposed on the second substrate. A pair of a first inner polarizer and a second inner polarizer sandwich the liquid crystal layer, and a color backlight device as above is disposed on one side of the second substrate, opposite to a side facing the liquid crystal layer.

The invention further provides a method of controlling color of a liquid crystal display, wherein the stimulated luminescent materials are arranged in a plurality of pixels. The stimulated luminescent materials emit more than one color. The thin-film transistor (TFT) array is controlled by a voltage and has a plurality of TFT clusters, wherein each TFT cluster corresponds to one pixel and each of TFT cluster contains n*m number of TFT element switch devices to control color switching of the pixel. The method of controlling the color display comprises switching x number of TFT element switch devices of the n*m number of TFT element switch devices to a first state according to an adjusted gray level, and switching the remaining (n*m−x) number of TFT element switch devices to a second state, wherein n and m is greater than or equal to one, and x is greater than or equal to zero.

The invention further provides a method of arranging a plurality of pixels of a color backlight device of a liquid crystal display as above, wherein the first strip electrode extends in a first direction perpendicular to a second direction and the stimulated luminescent materials have m number of types, m being greater than one. The method of arranging a plurality of pixels of the color backlight device comprises arranging the plurality of pixels of the color backlight device fully on the second substrate according to an arranging rule, wherein each pixel is filled with only one type of stimulated luminescent material, and each type of stimulated luminescent material is filled in the pixels on the second substrate respectively.

A detailed description is given in the following embodiments with reference to the accompanying drawings.

### BRIEF DESCRIPTION OF THE DRAWINGS

The invention can be more fully understood by reading the subsequent detailed description and examples with reference to the accompanying drawings, wherein:

FIG. 1 shows perspective view of a conventional surface conduction emitter display;

FIG. 2A-2C show cross sections of processes for forming one embodiment of a front substrate of a color backlight device of the invention;

FIG. 3A-3D show cross sections of four embodiments of a rear substrate of a color backlight device of the invention;

FIG. 4 shows a cross section of a color backlight device of one embodiment of the invention; and

FIG. 5 shows a cross section of a liquid crystal display of one embodiment of the invention, wherein the backlight is a color backlight device of the invention;

FIG. 6A-6F show plan views of six embodiments of a strip type arrangement of the pixels of a color backlight device of the invention;

FIG. 7 shows a plan view of one embodiment of a mosaic type arrangement of the pixels of a color backlight device of the invention;

FIG. 8 shows a plan view of one embodiment of a skeleton type arrangement of the pixels of a color backlight device of the invention;

FIG. 9 shows a plan view of one embodiment of a thin-film transistor substrate of a liquid crystal display of the invention;

FIG. 10 shows a plan view of one embodiment of a thin-film transistor substrate aligned with the pixels of a color backlight device of a liquid crystal display of the invention;

FIG. 11 shows a schematic plan view of five types of gray levels of n*m number of TFT element switch devices of one TFT cluster of the invention; and

FIG. 12 shows a schematic plan view of one embodiment of an adjusted gray level of the invention, wherein the adjusted gray level is controlled by a predetermined pattern.

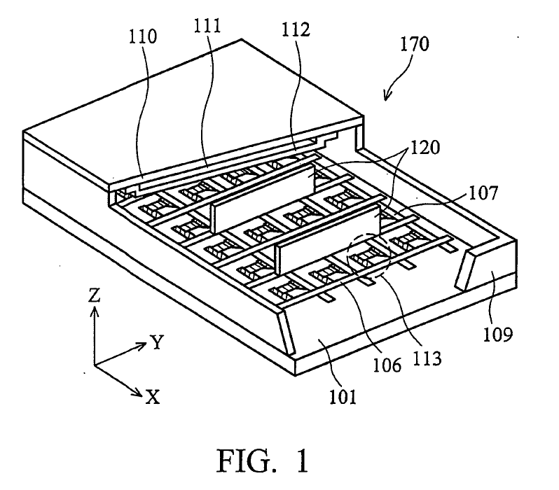

### DETAILED DESCRIPTION OF THE INVENTION

The following description is of the best-contemplated mode of carrying out the invention. The description is provided for illustrating the general principles of the invention and is not meant to be limiting. The scope of the invention is best determined by reference to the appended claims.

The invention utilizes a surface conduction emitter display (SED) mechanism to fabricate a color light source. The self-emitting light source with a passive matrix structure, thus all processes thereof can be achieved without masks. The advantages of SED technology include high contrast, dynamic character and high brightness, all of which are useful for a backlight device. The character of a method of fabricating a backlight module of the invention is no need of photolithography and etching process, and using inkjet printing or other printing to fabricate an electron emitter. The electron emitter is a major element in luminescence provided by the SED. The SED is capable of emitting electrons to stimulate the luminescence of phosphorus materials. Each pixel of the display has an electron emitter having a nano gap therein to provide electrons for bombarding the phosphorus materials to illuminate and as a pixel color backlight source.

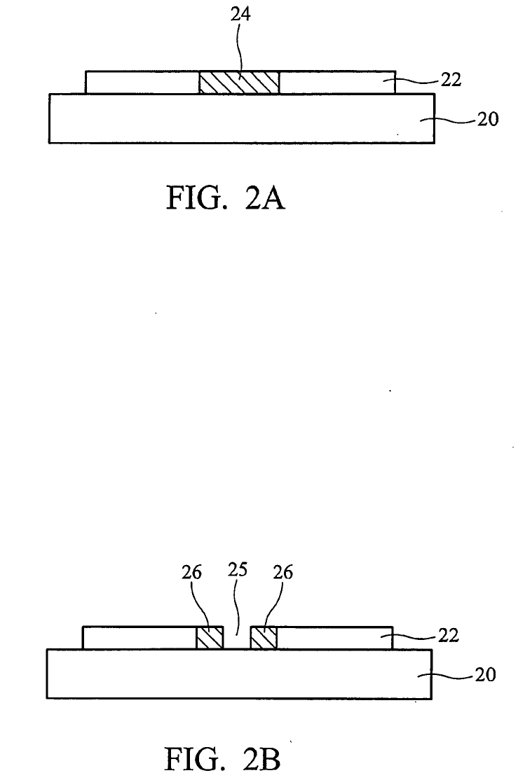

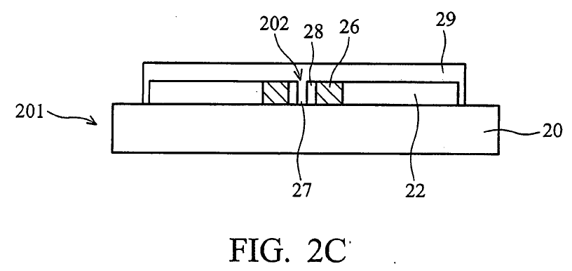

The color backlight device of the invention has a plurality of pixel light sources, as shown in FIGS. 2-4, which are embodiments of a device structure of one pixel light source. FIGS. 2A-2C, show cross sections of processes for forming one embodiment of a front substrate 201 of a color backlight device of the invention. As shown in FIG. 2A, a plurality of transparent strip electrodes 22 is disposed on a substrate 20. The material of the electrode 22 is a transparent conductive material such as indium tin oxide (ITO), indium zinc oxide (IZO), or poly-3,4-ethylenedioxythiophene (PEDOT). The method of forming the electrode 22 may be sputtering, vacuum deposition, spin coating, screen printing, or inkjet printing. A metal oxide such as PdO is subsequently coated on the electrode 22 by inkjet printing, impression printing or screen-printing to form a thin film 24. FIG. 2B, shows the thin film is dried at 300° C./1 hr to split, and then an electric field is applied on the split thin film 26 to form a conductance process such that a gap 25 of the thin film 26 can achieve a sub-micron level about 1-10 nm, wherein the electric field can be applied by direct current or alternating current. FIG. 2C, in a vacuum process environment, an organic gas such as a carbon-containing organic gas or a vapor of an organic solution is introduced and a square wave or a stringed wave pulse of high voltage about 100-1000V is applied to perform a conductance activation process depositing a carbon-containing film 28 on the thin film 26 such that a gap 27 in the thin film shrinks to a range between 4 to 6 nm, thus, an electron emitter 202 is formed. A dielectric layer 29 is then coated on the electron emitter to complete the processes for the front substrate 201.

The organic gas is decomposed under high temperature chemical vapor deposition (CVD) into carbon molecules deposited on the thin film, thus shrinking the gap of the thin film in the electron emitter of the SED panel. When a driving voltage is applied to the electron emitter, the gap of the thin film is narrower, the density of an electric field surrounding the gap is larger and the electric current of the electron emitter (i.e. the tunnel electric current through the gap) is higher. The higher electric current of the electron emitter the more discharge current flows toward the phosphorus material.

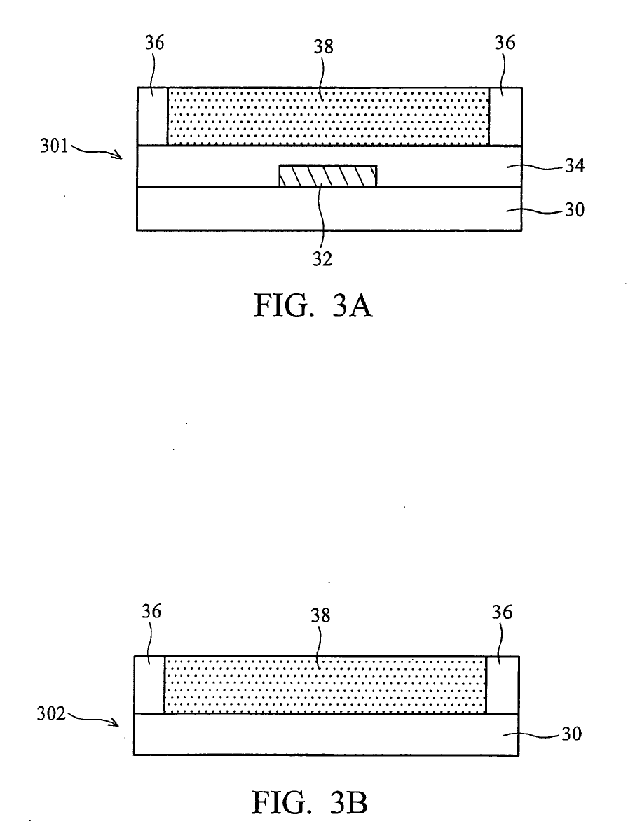

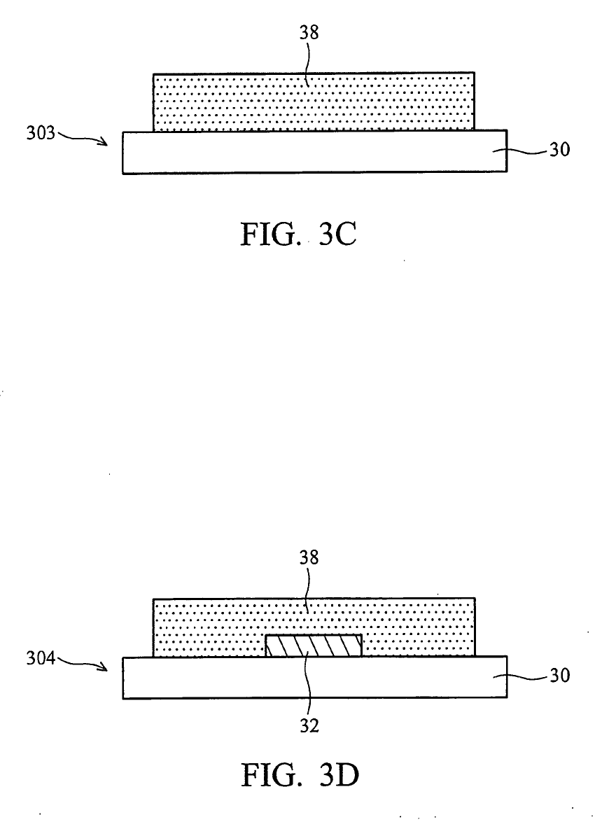

FIG. 3A shows a cross section of one embodiment of a rear substrate 301 of the color backlight device of the invention. A plurality of strip address electrodes 32 are formed on a substrate 30 by inkjet printing or other technologies. The material of the address electrodes 32 can be metal such as Au, Ag, or Cu. A dielectric layer 34 is then disposed on the address electrodes 32. The material of the dielectric layer may be poly(4-vinylphenol) (PVP), polymethyl methacrylate (PMMA), V₂O₅, TiO₂, or polyimide (PI). A plurality of strip ribs 36 is then disposed on the dielectric layer. The thickness of the rib on the rear substrate 301 can be used to adjust the gap between the front substrate and the rear substrate, thus, the rib and the address electrode are arranged in parallel. A plurality of stimulated luminescent materials 38 are then coated by a coating technology on the dielectric layer between the ribs to complete the rear substrate 301, and the coating technology is inkjet printing, impression printing, screen printing or similar. The stimulated luminescent material may be a phosphorus material or a fluorescent material, which emits a visible light of emission spectrum range between 300 to 800 nm by electron bombardment. The stimulated luminescent material comprises more than one type of phosphorus or fluorescent material which emits more than one color such as RGB, red, green, blue and white (RGBW), red, green, blue, cyan, magenta and yellow (RGBCMY) or combinations of more than one primary color.

FIG. 3B shows a cross section of another embodiment of a rear substrate 302 of the color backlight device of the invention. The rear substrate 302 of FIG. 3B, different from FIG. 3A, has no address electrode 32 and no dielectric layer 34. FIG. 3C, shows a cross section of another embodiment of a rear substrate 303 of the color backlight device of the invention. As shown in FIG. 3C, the ribs 36 of FIG. 3B are removed. FIG. 3D, shows a cross section of another embodiment of a rear substrate 304 of the color backlight device of the invention. As shown in FIG. 3D, the ribs 36 and the dielectric layer 34 of FIG. 3A are removed.

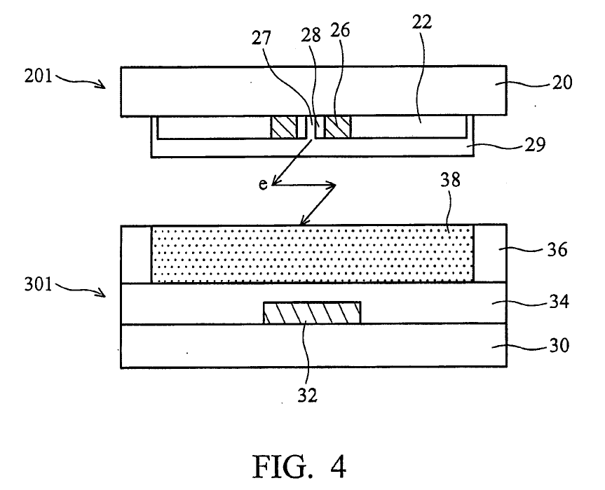

The above front substrate and one of the above rear substrate are assembled and sealed into the color backlight device of the invention. FIG. 4 shows another embodiment of the color backlight device of the invention including front substrate 201 and rear substrate is 301. The transparent strip electrodes 22 on the front substrate are arranged in parallel. After assembly of the front and rear substrates, the address electrodes 32 on the rear substrate and the transparent strip electrodes 22 are perpendicularly arranged or arranged in parallel. The stimulated luminescent materials on the rear substrate are aligned with the electron emitters 202 of the front substrate such that the electrons emitted from the electron emitter can bombard the stimulated luminescent material to emit a visible light.

The color backlight device of the invention utilizes two lighting driving methods, point lighting and line lighting. When the address electrode of the back substrate and the transparent strip electrode are perpendicularly arranged and the conventional passive matrix electrode is used to drive the color backlight device, the respective strip electrodes of the front and the back substrates are scanned simultaneously to induce electric field at the intersection of the two strip electrodes for producing and emitting point lighting. When the front substrate has transparent strip electrodes, by way of applying two reverse driving voltages (i.e. one positive and one negative) on the two adjacent parallel electrodes, will induce the electric field between strip electrodes emitting and produce the line lighting. When the transparent electrode of the front substrate and the address electrode of the rear substrate are arranged in parallel and using the passive matrix electrode to drive, the respective strip electrodes of the front and the rear substrates are scanned simultaneously to induce electric field between strip electrodes for producing and emitting another mode of line lighting. Because this mode of line lighting is driven by passive matrix electrode, the excited electrons are directly attracted by the electric field to bombard the phosphorus or fluorescent materials on the address electrodes of the rear substrate, lighting the display panel.

The invention provides a liquid crystal display with the above color backlight device, wherein a color filter of the conventional liquid crystal display is removed and the above color backlight device is used as a backlight source. The color backlight device is a self-lighting pixel light source with more than one color emitting light through the thin-film transistor switch, a liquid crystal, and polarizers to produce color display.

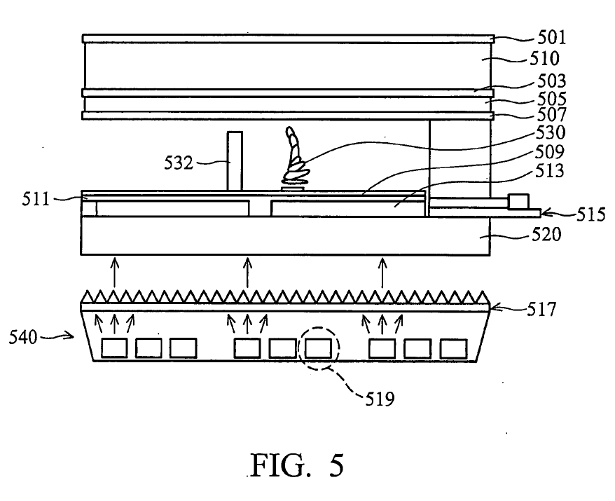

FIG. 5 shows a cross section of the liquid crystal display of one embodiment of the invention, wherein a front substrate 510 is disposed opposite to a rear substrate 520. A liquid crystal layer 530 and a plurality of spacers 532 are disposed between the front substrate 510 and the rear substrate 520. An optical film 501 is disposed on the front substrate 510, opposite to a side facing the liquid crystal layer. A transparent conductive layer 503 such as ITO is disposed below the front substrate facing the rear substrate. An inner polarizer 505 is disposed below the transparent conductive layer 503 and an alignment film 507 such as polyimide is disposed between the inner polarizer 505 and the liquid crystal layer 530. A TFT array electrode layer 513 is disposed on the rear substrate and a transparent conductive layer 515 such as ITO is disposed on a peripheral non-display area of the rear substrate. An inner polarizer 511 is disposed on the TFT array electrode layer 513 and an alignment film 509 such as polyimide is disposed between the inner polarizer 511 and the liquid crystal layer 530. The above color backlight device 540 is disposed under the rear substrate and an optical film 517 is disposed between the rear substrate and the color backlight device. The color backlight device 540 has a color light source of more than one primary color, wherein the structure of each pixel light source 519 is shown in FIG. 4.

The color backlight device of the invention can solve the problems posed by large area self-lighting backlight sources such as light emitting diodes (LED) or cold cathode fluorescent lights (CCFL) both of which suffer from no pixel fabrication. Although the large area color light source can serve adequately as the backlight source for liquid crystal display and a driving method such as an image sequencing method can adjust the display image, the large area light source flashes on the eyes of observers, thus, high quality image display is difficult to obtain. The invention thus utilizes surface conduction to emit electrons for bombarding the stimulated luminescent materials inducing light emission as a backlight. The invention additionally utilizes inkjet printing, replacing photolithography thus reducing costs.

There exist a variety of methods for arranging a plurality of pixels of the color backlight device with stimulated luminescent materials several of which are described in the following.

### Embodiment 1: Strip Type Arrangement

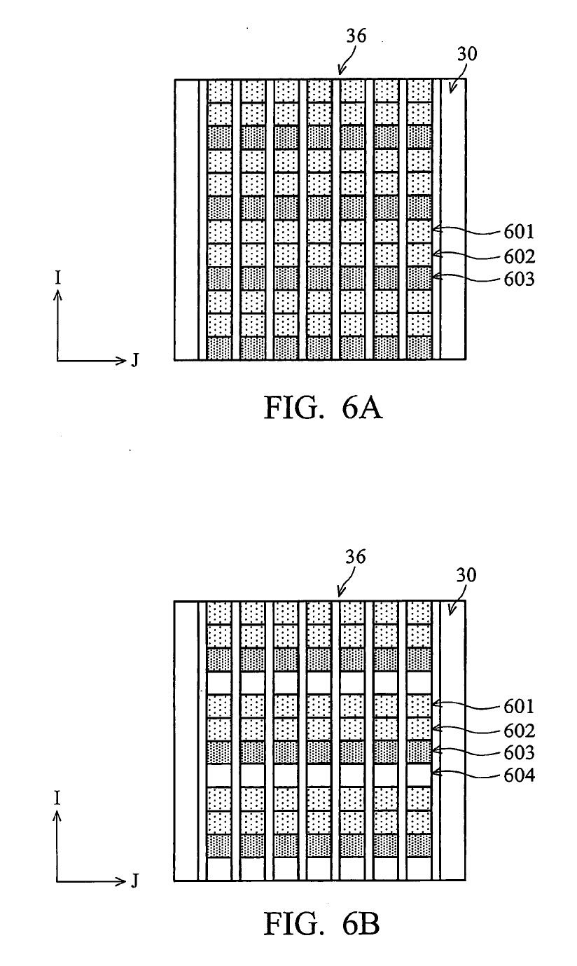

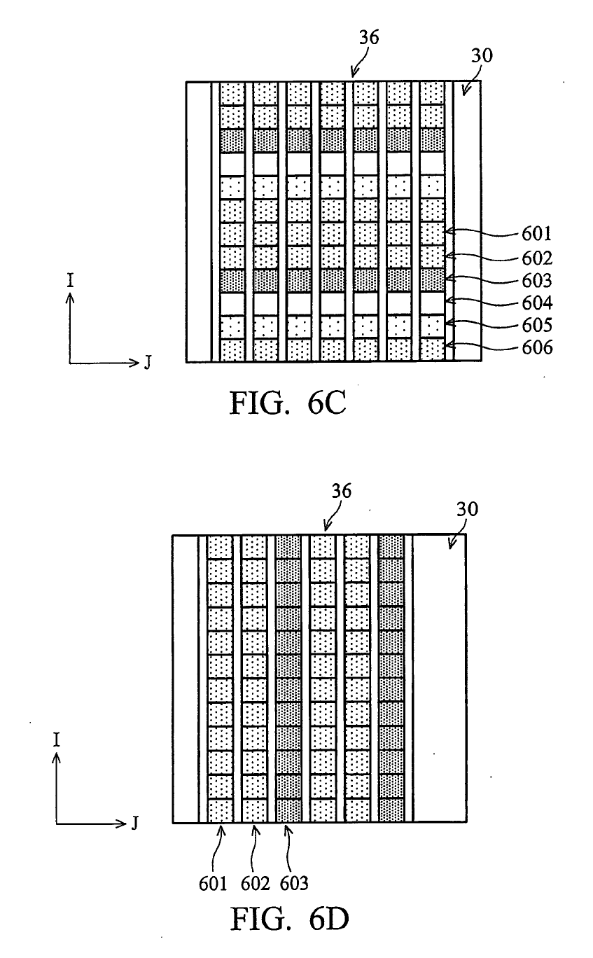

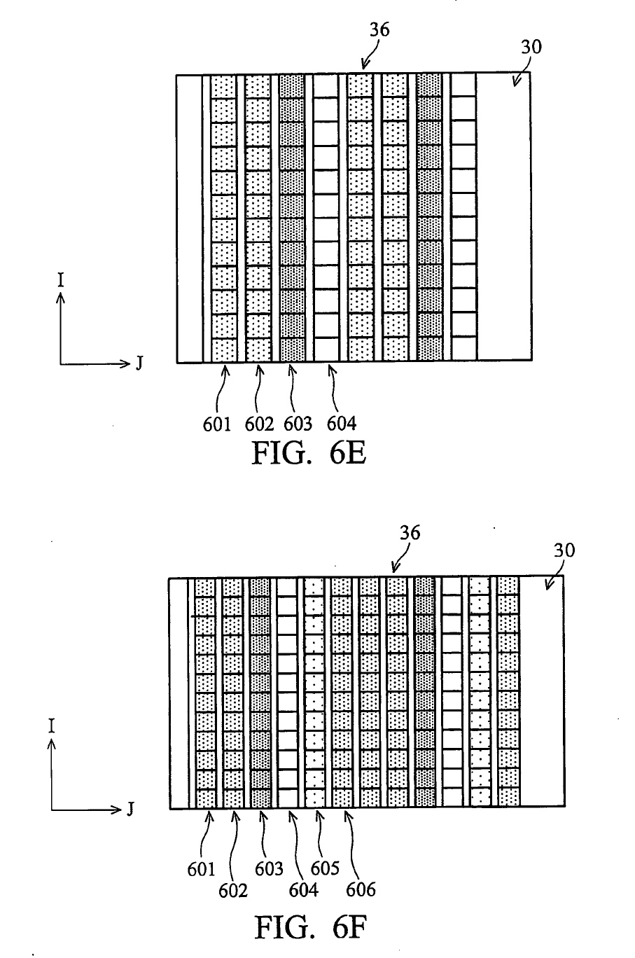

FIGS. 6A-6F show six different plan views of a strip type arrangement of the pixels of the rear substrate in a color backlight device. A plurality of ribs 36 is disposed on the rear substrate 30. The ribs and the transparent electrodes on the front substrate (not shown) are arranged in parallel in a direction I perpendicular to a direction J. There are a number m of different types of stimulated luminescent materials, where m is greater than one. Each pixel is filled with only one type of stimulated luminescent material and all pixels of the rear substrate are filled with m number of types of the stimulated luminescent materials according to an arranging rule.

As shown in FIG. 6A, there are three types of stimulated luminescent materials such as R, G, and B colors. The pixels along the direction J are filled with the same type of stimulated luminescent material, such as R color, and the pixels along the direction I are filled with different types of stimulated luminescent materials in sequence such as G, and B colors until the three types of stimulated luminescent materials are completely utilized. The arrangement of the three types of stimulated luminescent materials is then repeated until each pixel of the rear substrate is filled. In more detail, each pixel along the direction J filled with the same stimulated luminescent material, the first pixel along direction I is filled with the first type of stimulated luminescent material, the second pixel along direction I is filled with the second type of stimulated luminescent material until complete. The above arrangement is repeated until each pixel of the rear substrate 30 is filled with the stimulated luminescent material.

The method of arranging pixels in FIGS. 6B and 6C is the same as the arranging rule of FIG. 6A. The difference between FIGS. 6B and 6A is that there are four types of stimulated luminescent materials of FIG. 6B, such as R, G, B and W colors. The difference between FIGS. 6C and 6A is that there are six types of stimulated luminescent materials in FIG. 6C, such as R, G, B, C, M, and Y colors. Regardless of the number of types of the stimulated luminescent materials in FIG. 6A-6C, the pixels along direction J are filled with the same color of stimulated luminescent material into a horizontal strip type arrangement.

As shown in FIGS. 6D-6F, the direction of arranging the pixels filled with the stimulated luminescent materials is reverse to the direction of FIGS. 6A-6C. The method of arranging the pixels of FIGS. 6D-6F filled with stimulated luminescent materials is a vertical strip type arrangement. The arranging rule and the types of the stimulated luminescent materials of FIGS. 6D-6F are the same as FIGS. 6A-6C except for the direction of arrangement. In another word, the pixels along the direction I are filled with the same type of stimulated luminescent material, and the pixels along the direction J are filled with different types of stimulated luminescent materials in sequence until the m number of types of stimulated luminescent materials are used completely. Then arrangement of m number of types of stimulated luminescent materials is repeated until each pixel of the rear substrate is filled.

### Embodiment 2: Mosaic Type Arrangement

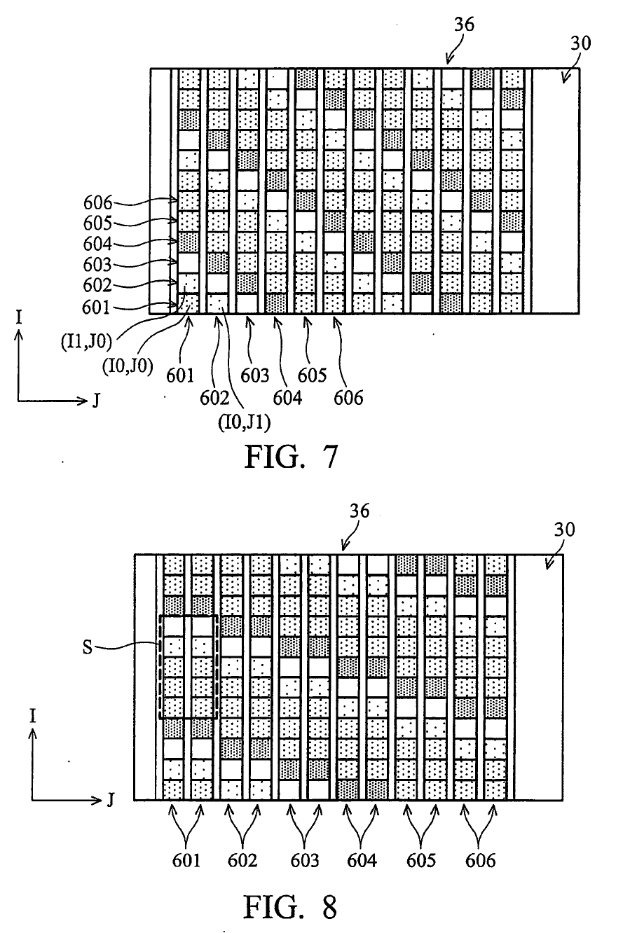

FIG. 7 shows a plan view of a mosaic type arrangement of the pixels on the rear substrate in a color backlight device, wherein a plurality of ribs 36 is disposed on the rear substrate 30. The ribs and the transparent electrodes on the front substrate (not shown) are arranged in parallel in a direction I perpendicular to a direction J. The stimulated luminescent materials have m number of types, where m is greater than one. Each pixel is filled with only one type of the stimulated luminescent material and all pixels of the rear substrate are filled with m number of types of the stimulated luminescent materials according to an arranging rule.

As shown in FIG. 7, the stimulated luminescent materials have six types such as R, G, B, C, M and Y colors. Every six pixels along direction I and direction J are filled with the same type of stimulated luminescent material such as R color, and the pixels along direction I and direction J are filled with different types of stimulated luminescent materials in sequence such as G, B, C, M and Y colors, and the arrangement of the six types of stimulated luminescent materials is repeated until each pixel of the rear substrate is filled and the mosaic type arrangement is completely formed.

In further detail, the arranging rule for forming the mosaic type arrangement of the pixels comprises the following conditions: (a) a coordinate of a reference pixel is (I0, J0), and every X number of pixels along direction I and every Y number of pixels along direction J are filled with the same type of stimulated luminescent material; (b) a coordinate of a new reference pixel (I1, J0) is obtained by shifting the reference pixel (I0, J0) along direction I with one pixel distance; (c) the stimulated luminescent material of the new reference pixel has K number of types, and K is between 1 to m; (d) repeats the steps (a) to (c) until each pixel of the rear substrate 30 is filled with the stimulated luminescent materials. A new reference pixel (I0, J1) can be obtained by shifting the reference pixel (I0, J0) along direction J by a distance of one pixel distance in the above step (b), and the other steps (a), (c), and (d) are the same as those previously described for forming the same mosaic type pixel arrangement.

### Embodiment 3: Skeleton Type Arrangement

FIG. 8 shows a plan view of a skeleton type arrangement of the pixels on the rear substrate in a color backlight device, wherein a plurality of ribs 36 is disposed on the rear substrate 30. The ribs and the transparent electrodes on the front substrate (not shown) are arranged in parallel in a direction I perpendicular to a direction J. The stimulated luminescent materials have m number of types, where m is greater than one. Each pixel is filled with only one type of stimulated luminescent material and all pixels of the rear substrate are filled with m number of types of the stimulated luminescent materials according to an arranging rule.

The arranging rule of forming the skeleton type arrangement of the pixels comprises the following conditions: (a) a skeleton with n number of pixels is provided, wherein n is divisible by m, and each of the different types of stimulated luminescent materials in the skeleton occupies the same number of pixels; (b) the skeleton is repeated in direction I A number of times; (c)the skeleton is repeated in B number of times direction J; (d) the steps (a) to (c) are repeated until all pixels of the rear substrate 30 are filled with the skeleton.

As shown in FIG. 8, there are six types of stimulated luminescent materials such as R, G, B, C, M and Y colors. The skeleton S has twelve pixels, wherein each type of stimulated luminescent material occupies two pixels. The skeleton S is repeatedly arranged along direction I and once down one pixel of direction I in sequence along direction J to form the skeleton type arrangement of pixels as shown in FIG. 8.

According to the arranging rule of the skeleton type arrangement of pixels, by adjusting the skeleton and the arrangement, the strip type arrangement as shown in FIGS. 6A-6F and the mosaic type arrangement as shown in FIG. 7 also can be obtained.

Utilizing the described pixel arranging methods of the stimulated luminescent materials, the electrons emitted from the electron emitter bombard the stimulated luminescent materials to emit a visible light with different colors as a backlight source. The TFT or diode array device is switched by a treating method such as the half-toning method. Thus, a display can present combinations of various gray levels of colors to achieve full color display. The display of the invention can be achieved without a color filter, and avoids the problem high failure rate of alignment of the front and the rear substrates. Additionally, the display does not require driver ICs for adjusting TFT voltage to control the liquid crystal. A simple switch of the I/O controller or a constant voltage controlling TFT can be utilized in the display to control liquid crystal. Opening or closing all pixel switches and a half-toning or dithering method can control the gray level to achieve full color display. The driver ICs of adjusting TFT voltage to control liquid crystal and the pixels switch also can be used in the display to obtain a higher resolution of the full color display image. A lower resolution driver IC, such as a six bit driver IC, can be combined with the pixel switches to achieve the same effect as a high resolution driver IC, such as an eight bit driver IC.

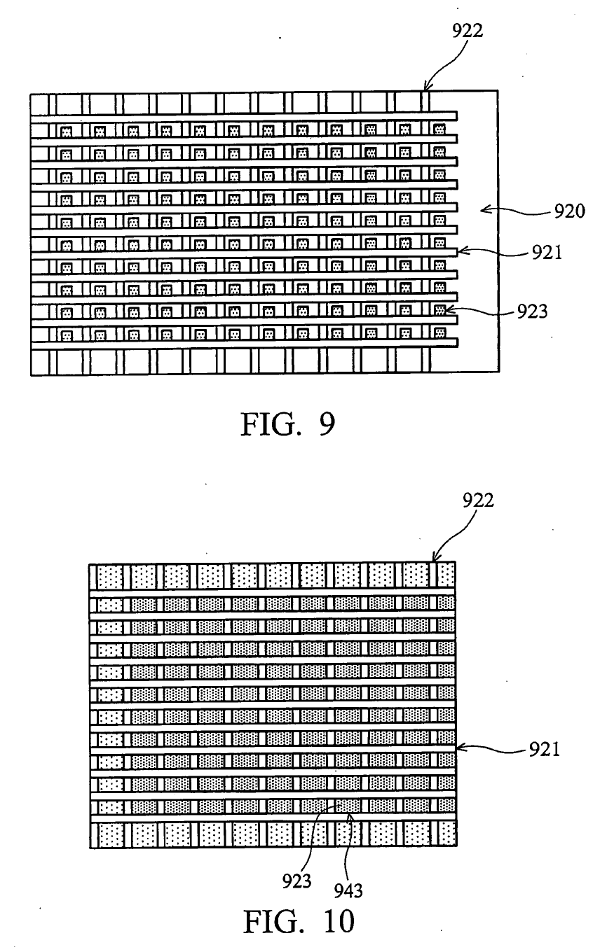

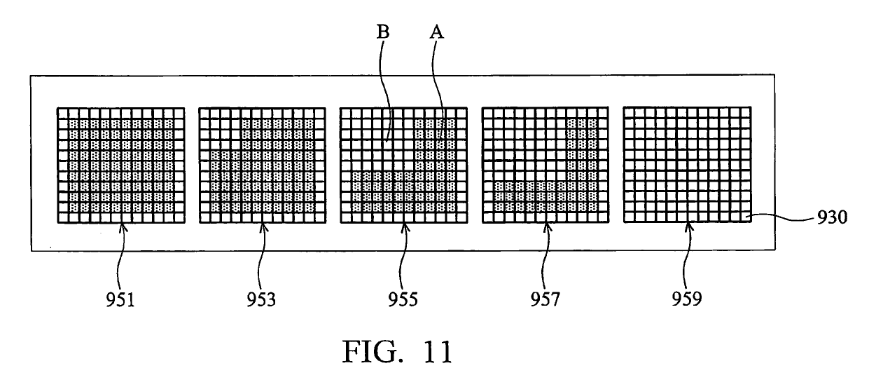

A method of controlling gray level color display of a display of the invention is used for the display comprising the described color backlight device and the TFT switch array controlled by a voltage, wherein the voltage can be constant or variable voltage. FIG. 9 shows a plurality of gate lines 921 and a plurality of data lines 922 disposed on a TFT substrate 920 of the display. A TFT cluster 923 is surrounded by the gate lines and the data lines. A plurality of TFT clusters is disposed on the TFT substrate. In FIG. 10, the TFT substrate is disposed corresponding to the color backlight device such that one TFT cluster 923 corresponds to one pixel 943 of the color backlight device. The stimulated luminescent materials are filled into the pixels of the color backlight device in sequence and emit more than one primary color. FIG. 11 shows a schematic plan view of five types of gray levels 951, 953, 955, 957, and 959 of n*m number of TFT element switch devices of one TFT cluster of the invention. Each TFT cluster may have n*m number of TFT element switch devices 930 to control color switching of the pixel.

In FIG. 11 again, the method for controlling a color display comprises switching x number of TFT element switch devices of the n*m number of TFT element switch devices to a first state A according to an adjusted gray level, and switching the remaining number of TFT element switch devices (n*m−x) to a second state B, wherein n and m are each greater than or equal to one, and x is greater than or equal to zero. The adjusted gray level can be controlled by a dither method, half-toning method or error diffusion method.

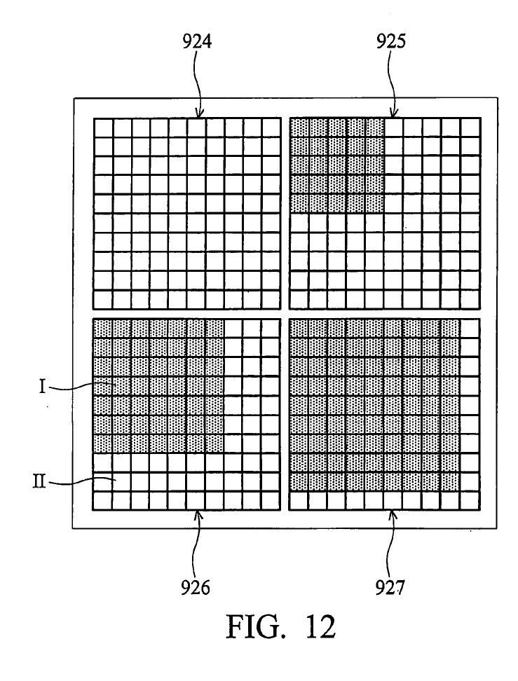

The adjusted gray level also can be controlled by a predetermined pattern as shown in FIG. 12 which is a schematic plan view of one embodiment of the invention with four TFT clusters. Each TFT cluster 924, 925, 926 and 927 has a different pattern. According to the predetermined pattern, the number of TFT element switch devices x are in the first state I, and the remaining number of TFT element switch devices (n*m−x) are in the second state II.

In the described method for controlling color displays, different pixels corresponding to stimulated luminescent materials that emit the same or different colors can also be controlled by the same controlling method for adjustment of gray levels. The different pixels corresponding to the stimulated luminescent materials emitting different colors can also be controlled by different controlling methods for adjusting gray levels. Each TFT cluster corresponding to the stimulated luminescent materials emitting different colors may have the same or a different number x.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A color backlight device, comprising:
a first substrate;
a plurality of first strip electrodes disposed on the first substrate;
a plurality of electron emitters disposed between the first strip electrodes;
a second substrate disposed opposite to the first substrate; and
a plurality of stimulated luminescent materials disposed on the second substrate aligned with the electron emitters.

2. The color backlight device as claimed in claim 1, further comprising a plurality of second strip electrodes disposed on the second substrate.

3. The color backlight device as claimed in claim 2, further comprising a dielectric layer disposed on the second strip electrode.

4. The color backlight device as claimed in claim 3, further comprising a plurality of ribs disposed on the dielectric layer, wherein the rib and the second strip electrode are arranged in parallel.

5. The color backlight device as claimed in claim 1, wherein the stimulated luminescent materials comprise a plurality of phosphorus or fluorescent materials capable of emitting more than one color by electron bombardment.

6. A method of fabricating a color backlight device, comprising:
providing a first substrate;
forming a plurality of first strip electrodes on the first substrate;
forming a plurality of thin films between the first strip electrodes by printing;
applying an electric field on the thin film to form a sub-micron gap therein;
performing an activation process on the thin films such that the sub-micron gap shrinks into a nano gap, thereby forming an electron emitter;
providing a second substrate;
disposing a plurality of stimulated luminescent materials on the second substrate; and
assembling the first substrate opposite to the second substrate such that the stimulated luminescent materials are aligned with the electron emitter.

7. The method as claimed in claim 6, further comprising forming a plurality of second strip electrodes on the second substrate.

8. The method as claimed in claim 7, further comprising forming a dielectric layer on the second strip electrode.

9. The method as claimed in claim 8, further comprising forming a plurality of ribs on the dielectric layer, wherein the rib and the second strip electrode are arranged in parallel.

10. The method as claimed in claim 6, wherein the activation process comprises introducing an organic gas to deposit a carbon-containing film on the thin film.

11. The method as claimed in claim 10, wherein the organic gas comprises a carbon-containing organic gas or a vapor of an organic solution.

12. The method as claimed in claim 6, wherein the stimulated luminescent materials comprise a plurality of phosphorus or fluorescent materials capable of emitting more than one color by electron bombardment.

13. The method as claimed in claim 6, wherein the step of printing comprises inkjet printing, impression printing or screen printing.

14. A liquid crystal display, comprising:
a first substrate;
a second substrate disposed opposite to the first substrate;
a liquid crystal layer disposed between the first substrate and the second substrate;
an electrode layer of a thin-film transistor array disposed on the second substrate;
a pair of a first inner polarizer and a second inner polarizer sandwiching the liquid crystal layer; and
a color backlight device as claimed in claim 1 disposed on one side of the second substrate, opposite to a side facing the liquid crystal layer.

15. The liquid crystal display as claimed in claim 14, further comprising a pair of a first optical film and a second optical film sandwiching the first substrate and the second substrate respectively.

16. The liquid crystal display as claimed in claim 14, further comprising a first polyimide layer disposed between the first inner polarizer and the liquid crystal layer.

17. The liquid crystal display as claimed in claim 16, further comprising a second polyimide layer disposed between the second inner polarizer and the liquid crystal layer.

18. The liquid crystal display as claimed in claim 14, further comprising a plurality of spacers disposed in the liquid crystal layer between the first substrate and the second substrate.

19. The liquid crystal display as claimed in claim 14, further comprising a first ITO layer disposed on the first substrate and facing the second substrate.

20. The liquid crystal display as claimed in claim 19, further comprising a second ITO layer disposed on a peripheral non-display area of the second substrate and facing the first substrate.

21. A method of controlling color display of a liquid crystal display as claimed in claim 14, wherein the stimulated luminescent materials are arranged in a plurality of pixels, and the stimulated luminescent materials emit more than one color, and the thin-film transistor (TFT) array is controlled by a voltage and has a plurality of TFT clusters, wherein each of the TFT cluster corresponds to one pixel and each of the TFT clusters contains n*m number of TFT element switch devices to control color switching of the pixel, the method of controlling color display comprising:
switching x number of TFT element switch devices of the n*m number of TFT element switch devices to a first state according to an adjusted gray level; and
switching the remaining (n*m−x) number of TFT element switch devices to a second state, wherein n and m is greater than or equal to one, and x is greater than or equal to zero.

22. The method as claimed in claim 21, wherein the adjusted gray level is controlled by a dither method, half-toning method or error diffusion method.

23. The method as claimed in claim 21, wherein the adjusted gray level is controlled by a predetermined pattern, wherein the number of TFT element switch devices x in the predetermined pattern are in the first state, and the remaining (n*m−x) number of TFT element switch devices in the predetermined pattern are in the second state.

24. The method as claimed in claim 21, wherein different pixels corresponding to the stimulated luminescent materials that emit the same color are controlled by the same control method for adjusting gray levels.

25. The method as claimed in claim 21, wherein different pixels corresponding to the stimulated luminescent materials capable of emitting different colors are controlled by the same control method for adjusting gray levels.

26. The method as claimed in claim 21, wherein the different pixels corresponding to the stimulated luminescent materials capable of emitting different colors are controlled by a different control method for adjusting gray levels.

27. The method as claimed in claim 25, wherein each TFT cluster corresponding to the stimulated luminescent materials capable of emitting different colors has the same number x.

28. The method as claimed in claim 25, wherein each TFT cluster corresponding to the stimulated luminescent materials capable of emitting different colors has a different number x.

29. The method as claimed in claim 26, wherein each TFT cluster corresponding to the stimulated luminescent materials capable of emitting different colors has the same number x.

30. The method as claimed in claim 26, wherein each TFT cluster corresponding to the stimulated luminescent materials capable of emitting different colors has a different number x.

31. A method of arranging a plurality of pixels of a color backlight device of a liquid crystal display as claimed in claim 14, wherein the first strip electrode extends in a first direction perpendicular to a second direction and m number of types of stimulated luminescent materials, m being greater than one, the method of arranging the pixels of the color backlight device comprising:
arranging the plurality of pixels of the color backlight device on the second substrate according to an arranging rule, wherein each pixel is filled with only one type of stimulated luminescent material, and each type of the stimulated luminescent material is filled in the pixels on the second substrate respectively.

32. The method as claimed in claim 31, wherein the arranging rule is a skeleton type arrangement.

33. The method as claimed in claim 32, wherein the skeleton type arrangement comprises:
providing a skeleton with n number of pixels, wherein n is divisible by m, and each different type of stimulated luminescent materials in the skeleton occupies the same number of pixels; and
repeating the skeleton in the first direction and the second direction until each pixel of the second substrate is filled.

34. The method as claimed in claim 32, wherein the skeleton type arrangement is a strip type arrangement.

35. The method as claimed in claim 34, wherein the pixels along the first direction are filled with the same type of stimulated luminescent material, and the pixels along the second direction are filled with different types of stimulated luminescent materials in sequence until the m number of types of stimulated luminescent materials are used completely, and the arrangement of the m number of types of stimulated luminescent materials is repeated until each pixel of the second substrate is filled.

36. The method as claimed in claim 34, wherein the pixels along the second direction are filled with the same type of stimulated luminescent material, and the pixels along the first direction are filled with different types of stimulated luminescent materials in sequence until the m number of types of stimulated luminescent materials are used completely, and the arrangement is repeated until each pixel of the second substrate is filled.

37. The method as claimed in claim 32, wherein the skeleton type arrangement is a mosaic type arrangement.

38. The method as claimed in claim 37, wherein every m number of pixels along the first direction and the second direction are filled with the same type of stimulated luminescent material, and the pixels along the first direction and the second direction are filled with different types of stimulated luminescent materials in sequence, and the arrangement of the m number of types of stimulated luminescent materials is repeated until each pixel of the second substrate is filled.

39. The method as claimed in claim 31, wherein the stimulated luminescent material comprises a phosphorus material or a fluorescent material.

40. The method as claimed in claim 39, wherein the emission spectrum of the phosphorus or the fluorescent material is at a visible light range between 300 to 800 nm.
